(19) United States
(12) Patent Application Publication
(10) Pub. No.: US 2015/0305582 A1
(43) Pub. Date: Oct. 29, 2015

(54) GREASE TRAP CLEANER

(71) Applicant: ENI TECH, Yuseong-gu Daejeon (KR)

(72) Inventor: Geun Su YOO, Daejeon (KR)

(21) Appl. No.: 14/441,796

(22) PCT Filed: Jul. 30, 2014
(86) PCT No.: PCT/KR2014/007014

§ 371 Date: May 8, 2015

(30) Foreign Application Priority Data
Aug. 7, 2013 (KR) 10-2013-0093773

(51) Int. Cl. A47L 7/00; B08B 5/04; B01D 17/02

(52) U.S. Cl. CPC A47L 7/0004; A47L 7/0023; A47L 7/0033; B01D 17/02; B08B 5/04

(57) ABSTRACT

Disclosed is a grease trap cleaner configured to suction contaminants including, for example, sludge and waste fat collected in a grease trap and to treat the contaminants by separating the waste fat and dehydrating the sludge, the cleaner exhibiting convenient movement owing to movement wheels provided thereat and being capable of suctioning and treating both wet and dry impurities and of preventing, for example, environmental pollution, food poisoning and blockage of sewage pipes owing to cleaning of a grease trap.

### TECHNICAL FIELD

The present invention relates to a grease trap cleaner and, more particularly, to a grease trap cleaner which is configured to suction contaminants including, for example, sludge and waste fat collected in a grease trap and to treat the contaminants by separating the waste fat and dehydrating the sludge, the cleaner exhibiting convenient movement owing to movement wheels provided thereat and being capable of suctioning and treating both wet and dry impurities and of preventing, for example, environmental pollution, food poisoning and blockage of sewage pipes owing to cleaning of a grease trap.

### BACKGROUND ART

A grease trap is installed in large scale foodservice facilities such as, for example, schools and companies and includes a partition to separate waste fat from food waste using a net and a specific gravity difference.

However, a general grease trap cannot effectively deal with a fast flow rate in a narrow space and tends to cause environmental pollution and infectious diseases.

In addition, environmental pollution due to improper management of the grease trap is a serious problem.

Although various dry and wet vacuum cleaners have been introduced to solve the problems as described above, conventional dry cleaners are configured to mainly suction dry impurities.

Wet cleaners are large capacity and high price cleaners, although they are capable of suctioning moisture and sludge, and, therefore, have a limit in treatment of a small amount of contaminants.

In addition, wet cleaners are adapted to separate the suctioned moisture and sludge via a gravitational flow manner, thus having deterioration in the treatment efficiency of contaminants.

Korean Patent Laid-Open Publication No. 1997-0009734 discloses a “head reservoir type water-jet cleaner using a water level sensor”, which is configured to eject water supplied from a purified water storage tank of a main body and to suction wastewater containing captured impurities from the bottom thereof.

The head reservoir type water-jet cleaner using the water level sensor has an advantage of facilitating easy cleaning of a material including moisture and sludge, but problematically suctions waste fat or oil components contained in the moisture and sludge.

Accordingly, the above-described conventional cleaner requires an operation for separating waste fat from suctioned contaminants, thus suffering from inconvenience due to such operation and deterioration in the treatment efficiency of contaminants.

### DISCLOSURE

### Technical Problem

The present invention has been devised to solve the problems as described above and one object of the present invention is to provide a grease trap cleaner which is capable of keeping a grease trap clean by suctioning various contaminants including food waste collected in the grease trap.

In particular, another object of the present invention is to provide a grease trap cleaner which is capable of preventing environmental pollution, food poisoning, and blockage of sewage pipes by suctioning various contaminants including food waste collected in a grease trap.

In addition, another object of the present invention is to provide a grease trap cleaner which is capable of preventing water pollution due to waste fat by suctioning various contaminants including food waste collected in a grease trap and separating waste fat and oil from the contaminants so as to separately store the same for later recovery thereof.

In addition, another object of the present invention is to provide a grease trap cleaner which is capable of achieving good recycling efficiency and reduced labor and operating costs by pumping sewage, from which waste fat has been separated, to a suction hose or a vacuum pump so as to allow the sewage to again be used when the grease trap cleaner performs treatment of contaminants inside a grease trap.

In addition, another object of the present invention is to provide a grease trap cleaner which is capable of achieving easy transportability using movement wheels and of treating both dry and wet impurities.

In addition, a further object of the present invention is to provide a grease trap cleaner which may be applied, in addition to foodservice facilities, to cleaning of small scale sewage pipes and to collection of waste water and oil leaked from the bottom of a ship.

### Technical Solution

In accordance with one embodiment of the present invention, the above and other objects can be accomplished by the provision of a grease trap cleaner including a suction hose 100 configured to suction contaminants, a first pump 10 configured to generate suction force for suction of the contaminants into the cleaner, a centrifugal separator unit 300 configured to receive the contaminants, suctioned through the suction hose 100, from a supply pipe 101 and to separate the contaminants into solids and liquids, and a liquid separation unit configured to receive the liquids separated by the centrifugal separator unit such that the liquids are separated into sewage and waste fat, wherein the liquid separation unit includes a separator having an air bubble diffuser configured to separate the liquids into sewage and waste fat, a sewage reservoir configured to store the sewage therein, a waste fat collector configured to collect the waste fat, and a waste fat reservoir configured to store the waste fat collected by the waste fat collector.

In particular, the grease trap cleaner may further include a second pump connected to the sewage reservoir, and the second pump may be configured to supply water to the first pump or a nozzle unit located at a leading end of the suction hose to eject water.

In addition, the suction hose may include a magnet provided at the leading end thereof.

In addition, the centrifugal separator unit may include a separation container configured to receive the suctioned contaminants, a motor located below the separation container to rotate the separation container, and a distributor located above the separation container to uniformly distribute the suctioned contaminants to the separation container.

In addition, the grease trap cleaner may further include a third pump configured to discharge the sewage of the sewage reservoir through a discharge unit.

In addition, the grease trap cleaner may further include a grinding device provided at a leading end of the pump to grind the contaminants.

In addition, the grease trap cleaner may further include a movement wheel configured to be electrically driven.

### Advantageous Effects

A grease trap cleaner according to the present invention has an advantage of keeping a grease trap clean by suctioning various contaminants including food waste collected in the grease trap.

In particular, the grease trap cleaner according to the present invention has an advantage of preventing environmental pollution, food poisoning, and blockage of sewage pipes by suctioning various contaminants including food waste collected in the grease trap.

In addition, the grease trap cleaner according to the present invention has an advantage of preventing water pollution due to waste fat by suctioning various contaminants including food waste collected in the grease trap and separating waste fat and oil from the contaminants so as to separately store the same for later recovery thereof.

In addition, the grease trap cleaner according to the present invention has an advantage of achieving good recycling efficiency and reduced labor and operating costs by pumping sewage, from which waste fat has been separated, to a suction hose or a vacuum pump so as to allow the sewage to again be used when the grease trap cleaner performs treatment of contaminants inside the grease trap.

In addition, the grease trap cleaner according to the present invention has an advantage of achieving high transportability using movement wheels and of treating both dry and wet impurities.

In addition, the grease trap cleaner according to the present invention has an advantage of being applied, in addition to foodservice facilities, to cleaning of small scale sewage pipes and to collection of waste water and oil leaked from the bottom of a ship.

### DESCRIPTION OF DRAWINGS

FIG. 1 is a view illustrating a conventional wet cleaner.

FIG. 2 is a view schematically illustrating an outer appearance of a grease trap cleaner according to the present invention.

FIG. 3 is a view schematically illustrating a body of the grease trap cleaner according to the present invention.

FIG. 4 is a view schematically illustrating a liquid separation unit of the grease trap cleaner according to the present invention.

FIG. 5 is a view schematically illustrating a suction hose of the grease trap cleaner according to the present invention.

FIG. 6 is a view schematically illustrating a grinding device located at a leading end of a first pump according to the present invention.

### BEST MODE

Hereinafter, a pneumatic connector fixing device according to the present invention having features as described above will be described in detail with reference to the accompanying drawings.

Prior to describing the present invention, the terms or words used in the specification and claims of the present invention are not interpreted using typical or dictionary limited meanings, and are constructed as meanings and concepts conforming to the technical sprit of the present invention based on the principle that the inventors can appropriately define the concepts of the terms to explain the present invention in the best manner.

Accordingly, it is to be understood that the detailed description, which will be disclosed along with the accompanying drawings, is intended to describe the exemplary embodiments of the present invention and is not intended to represent all technical ideas of the present invention. Therefore, it should be understood that various equivalents and modifications can exist which can replace the embodiments described in the time of the application.

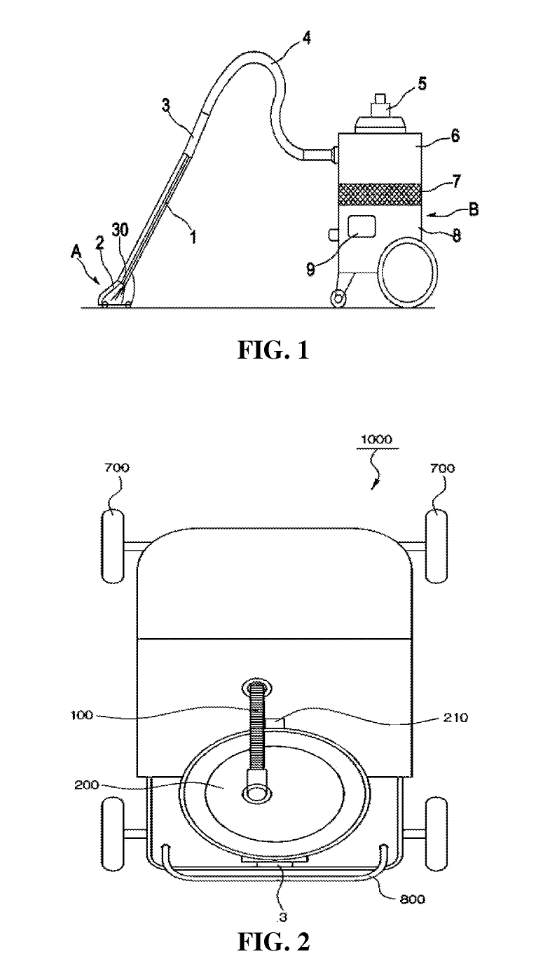

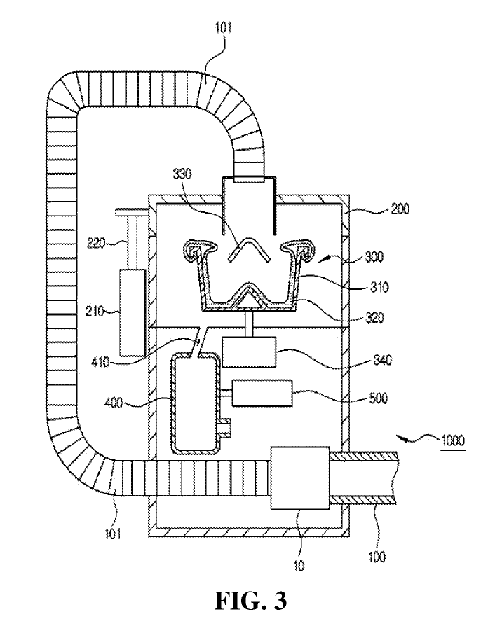

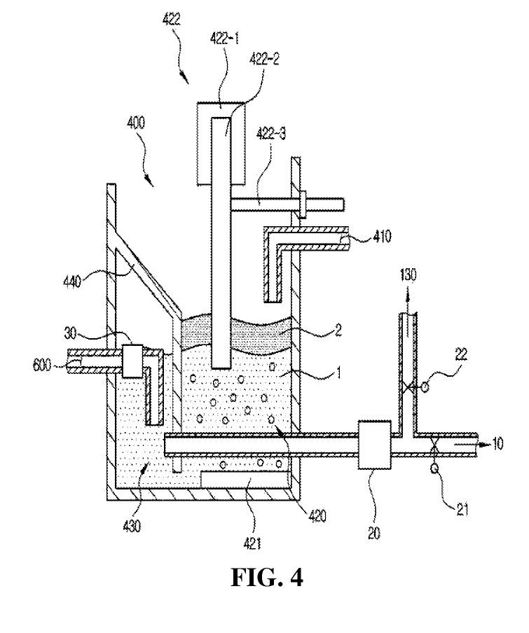

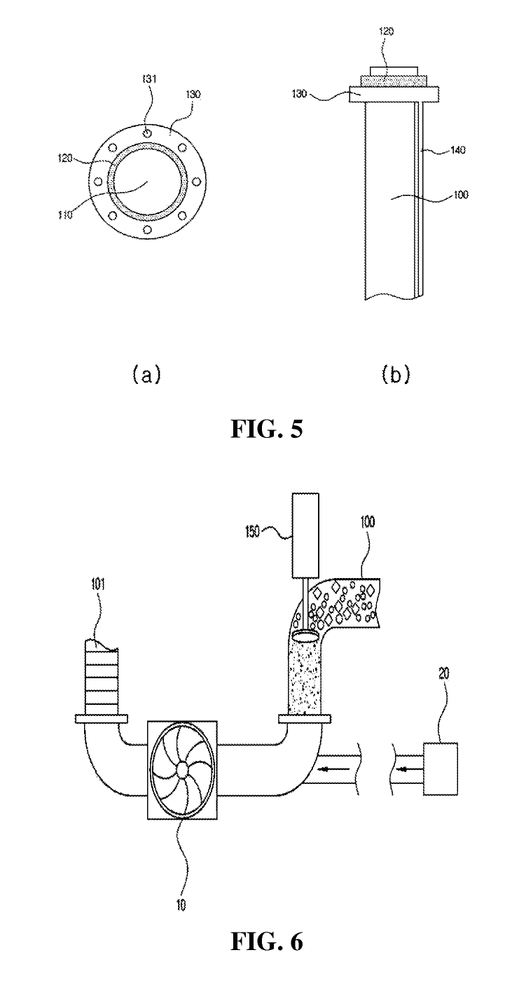

FIG. 1 is a view illustrating a conventional wet cleaner, FIG. 2 is a view schematically illustrating an outer appearance of a grease trap cleaner according to the present invention, FIG. 3 is a view schematically illustrating a body of the grease trap cleaner according to the present invention, FIG. 4 is a view schematically illustrating a liquid separation unit of the grease trap cleaner according to the present invention, FIG. 5 is a view schematically illustrating a suction hose 100 of the grease trap cleaner according to the present invention, and FIG. 6 is a view schematically illustrating a grinding device located at a leading end of a first pump 10 according to the present invention.

As exemplarily illustrated in FIGS. 2 and 3, the grease strap cleaner according to the present invention is configured in such a manner that contaminants are suctioned into a suction hose 100 via operation of a first pump 10 that generates suction force to suction the contaminants into the cleaner.

The contaminants, suctioned through the suction hose 100, are directed to a centrifugal separator unit 300 by way of the first pump 10 and a supply pipe 101 so as to be separated into solids and liquids in the centrifugal separator unit 300. The separated solids are recovered and the liquids are supplied to a liquid separation unit 400.

The liquids, supplied to the liquid separation unit 400, are separated into sewage and waste fat in a separator 420. Then, the sewage is stored in or temporarily stored in and discharged from a sewage reservoir 430 and the waste fat is stored in a waste fat reservoir 500 for later recovery.

A further detailed description of the grease trap cleaner according to the present invention is now given. As exemplarily illustrated in FIGS. 2 and 3, the contaminants, suctioned through the suction hose 100, are received in a separation container 310 of the centrifugal separator unit 300.

The separation container 310 is rotated by a motor 340 located therebelow, thereby separating the contaminants into solids and liquids.

The separation container 310 may have a cylindrical shape for centrifugal separation and includes a non-woven fabric bag 320. As such, the solid-phase contaminants may be recovered by simply removing the non-woven fabric bag 320 after dehydration.

In addition, as a preparation for the case in which the non-woven fabric bag 320 is not provided, the separation container 310 may take the form of a cylinder having fine pores to permit passage of a fluid only. The solid-phase contaminants may be recovered via centrifugal separation using the separation container 310 having the fine pores.

The centrifugal separator unit 300 further includes a cone shaped distributor 330 located above the separation container 310.

The distributor 330 may serve to prevent the contaminants from being introduced in only one direction to the separation container 310, thereby preventing generation of abnormal vibration.

The liquids, separated in the centrifugal separator unit 300, are supplied to the liquid separation unit 400 through an inlet port 410 so as to be separated into sewage and waste fat.

As exemplarily illustrated in FIG. 4, the separator 420 of the liquid separation unit 400 includes an air bubble diffuser 421 to separate the liquids into the sewage and the waste fat.

As the air bubble diffuser 421 of the separator 420 generates air bubbles, the waste fat floats and is separated by specific gravity and aeration.

In addition, the floated waste fat is stored in the waste fat reservoir 500 by a waste fat collector 422 prior to being recovered. The sewage is stored in the sewage reservoir 430 that is delimited by a partition 440 and thereafter discharged through a discharge unit 600 via operation of a third pump 30.

The sewage reservoir 430 is provided with a floating water level sensor. When the floating waver level sensor senses an abnormal level of water, the third pump 30 is driven to discharge water.

The waste fat collector 422 may employ all of a skimmer manner, a filter manner and a cyclone manner to collect the waste fat. For example, as exemplarily illustrated in FIG. 4, the waste fat collector 422 includes a wheel shaft 422-3, and a collection wheel 422-2 and a scraper 422-1 which are coupled to the wheel shaft 422-3.

As exemplarily illustrated in FIG. 4, the grease trap cleaner according to the present invention includes a second pump 20 connected to the sewage reservoir 430.

The second pump 20 supplies water to the first pump 10 or a nozzle unit 130 that is located at a leading end of the suction hose.

In other words, the second pump 20 supplies water to the first pump 10 under control of a first valve 21 that is installed to a first pump pipe connected to the first pump 10. The second pump 20 also supplies water to the nozzle unit 130 located at the leading end of the suction hose under control of a second valve 22 that is installed to a supply pipe connected to a supply hose 140. The supply hose is located at one side of the suction hose 100. The first valve 21 and the second valve 22 are solenoid valves.

The water, supplied to a leading end of the first pump 10, serves to prevent loss of the pump and to maintain a suction vacuum when the first pump 10 performs idle rotation.

As exemplarily illustrated in FIG. 5, the suction hose 100 is provided at the leading end thereof with the nozzle unit 130 to eject water. The water of the sewage reservoir 430 is supplied to the nozzle unit 130 through the supply hose 140 that is located at one side of the suction hose 100 via operation of the second pump 20.

Contaminants accumulated in corners or on the bottom of the grease trap are not efficiently suctioned and, therefore, water needs to be ejected through nozzles 131 of the nozzle unit 130 located at the leading end of the suction hose 100 to enable suction of the contaminants.

In other words, as water is ejected through the nozzle unit 130 to stir the contaminants so as to facilitate suction of the contaminants, even the contaminants present at locations where suction is difficult inside the grease trap can be easily suctioned, which advantageously increases suction efficiency.

In addition, recycling the water used in the grease trap cleaner of the present invention has the effect of reducing treatment costs.

In addition, the water, supplied to the first pump 10 or the nozzle unit 130 of the suction hose 100 via the second pump 20, may be water recycled from water stored in the sewage reservoir 430, or may be supplied from a separate water tank (not illustrated).

As exemplarily illustrated in FIG. 5, the suction hose 100 is provided at the leading end thereof with a magnet 120.

The magnet 120 functions to primarily filter magnetic contaminants, thereby preventing damage to the first pump 10 and other equipment inside the grease trap cleaner of the present invention.

As exemplarily illustrated in FIG. 6, the grease trap cleaner of the present invention includes a grinding device 150 located at the leading end of the first pump 10.

The grinding device 150 serves to grind contaminants having a predetermined size or larger using a grinder. As such, the grinding device may prevent blockage of the first pump 10 and increase dehydration operation efficiency of the centrifugal separator unit 300.

As exemplarily illustrated in FIGS. 2 and 3, the grease trap cleaner according to the present invention includes an opening/closing cover 200 which enables recovery of the treated solid-phase contaminants and waste fat and also prevents generation of foul odors.

The cover 200 may be opened or closed using a motor or an air actuator 210 and may be operated in various other manners by a worker.

In addition, as exemplarily illustrated in FIG. 2, the grease trap cleaner according to the present invention includes electrically driven type movement wheels 700.

The electrically driven type movement wheels 700 have an advantage of increasing transportability of the grease trap cleaner by the worker.

In addition, the grease trap cleaner according to the present invention includes a storage battery (not illustrated) for driving of the electrically driven type movement wheels 700, the first pump 10, the second pump 20, and the third pump 30.

In addition, the grease trap cleaner further includes a handle 800 for transportability and safety thereof.

In addition, the grease trap cleaner according to the present invention is provided with an operating switch 3 to initiate operation of the cleaner.

As is apparent from the above description, a grease trap cleaner according to the present invention as described above has an advantage of keeping a grease trap clean by suctioning various contaminants including food waste collected in the grease trap.

In particular, the grease trap cleaner according to the present invention has an advantage of preventing environmental pollution, food poisoning, and blockage of sewage pipes by suctioning various contaminants including food waste collected in the grease trap.

In addition, the grease trap cleaner according to the present invention has an advantage of preventing water pollution due to waste fat by suctioning various contaminants including food waste collected in the grease trap and separating waste fat and oil from the contaminants so as to separately store the same for later recovery thereof.

In addition, the grease trap cleaner according to the present invention has an advantage of achieving good recycling efficiency and reduced labor and operating costs by pumping sewage, from which waste fat has been separated, to a suction hose 100 or a vacuum pump so as to allow the sewage to again be used when the grease trap cleaner performs treatment of contaminants inside the grease trap.

In addition, the grease trap cleaner according to the present invention has an advantage of achieving high transportability using movement wheels 700 and of treating both dry and wet impurities.

In addition, the grease trap cleaner according to the present invention has an advantage of being applied, in addition to foodservice facilities, to cleaning of small scale sewage pipes and to collection of waste water and oil leaked from the bottom of a ship.

### Description of Reference Numerals

1000: grease trap cleaner

100: suction hose

101: supply pipe

110: suction port

120: magnet

130: nozzle unit

131: nozzle

140: supply hose

150: grinding device

200: cover

210: actuator 220: shaft

300: centrifugal separator unit

310: separation container 320: non-woven fabric bag

330: distributor 340: motor

400: liquid separation unit

410: inlet port

420: separator 430: sewage reservoir

421: air bubble diffuser

422: waste fat collector

422-1: scraper 422-2: collection wheel

422-3: wheel shaft

440: partition

500: waste fat reservoir

600: discharge unit

700: movement wheels

800: handle

10: first pump

20: second pump

30: third pump

21: first solenoid valve 22: second solenoid valve

1: sewage

2: waste fat layer

3: operating switch

1. A grease trap cleaner comprising:
a suction hose 100 configured to suction contaminants:
a first pump 10 configured to generate suction force for suction of the contaminants into the cleaner;
a centrifugal separator unit 300 configured to receive the contaminants, suctioned through the suction hose 100, from a supply pipe 101 and to separate the contaminants into solids and liquids;
a liquid separation unit 400 configured to receive the liquids separated by the centrifugal separator unit 300 such that the liquids are separated into sewage and waste fat, wherein the liquid separation unit 400 includes:
a separator 420 having an air bubble diffuser 421 configured to separate the liquids into sewage and waste fat;
a sewage reservoir 430 configured to store the sewage therein;
a waste fat collector 422 configured to collect the waste fat; and
a waste fat reservoir 500 configured to store the waste fat collected by the waste fat collector 422; and
a second pump 20 connected to the sewage reservoir 430 and configured to supply water of the sewage reservoir 430 to the first pump 10 and a nozzle unit 130 located at a leading end of the suction hose 100,
wherein the second pump 20 is configured to supply water to the first pump 10 under control of a first valve 21 installed to a first pump pipe connected to the first pump 10 and to supply water to the nozzle unit 130 under control of a second valve 22 installed to a supply pipe connected to a supply hose 140 located at one side of the suction hose 100.

2. The grease trap cleaner according to claim 1, wherein the suction hose 100 includes a magnet 120 provided at the leading end thereof.

3. The grease trap cleaner according to claim 1, wherein the centrifugal separator unit 300 includes:
a separation container 310 configured to receive the suctioned contaminants;
a motor 340 located below the separation container 310 to rotate the separation container 310; and
a distributor 330 located above the separation container 310 to uniformly distribute the suctioned contaminants to the separation container 310.

4. The grease trap cleaner according to claim 1, wherein the grease trap cleaner 1000 further comprises a third pump 30 configured to discharge the sewage of the sewage reservoir 430 through a discharge unit 600.

5. The grease trap cleaner according to claim 1, wherein the grease trap cleaner 1000 further comprises a grinding device 150 provided at a leading end of the pump 10 to grind the contaminants.

6. The grease trap cleaner according to claim 1, wherein the grease trap cleaner 1000 further comprises a movement wheel 700 configured to be electrically driven.
